(19) United States
(12) Patent Application Publication
(10) Pub. No.: US 2005/0144268 A1
(43) Pub. Date: Jun. 30, 2005

(54) Managing spare devices on a finite network

(76) Inventors: Mohammad El-Batal, Westminster, CO (US); Bret Weber, Wichita, KS (US); Mark Nossokoff, Fort Collins, CO (US)

Correspondence Address: LSI LOGIC CORPORATION, 1621 BARBER LANE, MS: D-106, MILPITAS, CA, 95035, US

(21) Appl. No.: 10/731,190

(22) Filed: Dec. 8, 2003

(51) Int. Cl. G06F 15/173

(52) U.S. Cl. 709/223

(57) ABSTRACT

A network has a finite number of addressable devices plus an additional number of spare devices. A system and method is provided for switching out a failed device and switching in a spare device. A controller is connected to a switch for each device, allowing the controller to connect the device to the network. When a device is switched off the network and a new device connected thereto, the newly connected device is able to arbitrate for the address previously allocated to the removed device. In such a manner, an unlimited number of spare devices may be provided for a network with only a finite number of addressable devices.

### BACKGROUND OF THE INVENTION

a. Field of the Invention

The present invention pertains generally to communication networks with a finite number of addresses and more specifically to the management of devices on the network.

b. Description of the Background

Various network communication protocols are used to control and communicate with multiple devices throughout industry. In many cases, the network may have a finite number of addresses, yet there may be a need for additional devices on the network over and above the maximum number of addresses.

For example, a network with finite number of addresses may be used to control and communicate with an array of storage devices, such as hard disk drives. In such an example, the maximum number of disk drives may be determined by the maximum number of addresses.

In some applications, the spare devices may be counted among the devices that are initially connected to the network. In doing so, the maximum number of available devices is the maximum number of addressable devices minus the number of spare devices. In such applications, the system designer must consider very carefully the number of spares, since each additional spare device is taking away from the number of useable devices.

In the example of a disk array system, if 16 addressable devices were available, the designer may determine that three spare devices are required. Thus, only 13 devices are actually useable while three address spaces are allocated for spares, should one of the 13 devices fail. By allocating only three devices as spares, the designer may be limiting the ability for the system to survive successive failures at the same time the initial capacity of the system is further limited.

It would therefore be advantageous to provide a system and method for managing spare devices on a network wherein the spare devices are in excess of the maximum number of addressable devices on the network. It would be further advantageous if such system did not limit the amount of spare devices available.

### SUMMARY OF THE INVENTION

The present invention overcomes the disadvantages and limitations of previous solutions by providing a system and method for switching out a failed device and switching in a spare device. A controller is connected to a switch for each device, allowing the controller to connect the device to the network. When a device is switched off the network and a new device connected thereto, the newly connected device is able to arbitrate for the address previously allocated to the removed device.

An embodiment of the present invention may therefore comprise a method for managing more devices on a network than the maximum number of addresses comprising: providing the maximum number of devices; connecting the maximum number of devices to the network; setting an individual address for each of the maximum number of devices; providing at least one spare device, the at least one spare device being capable of determining and using addresses of failed devices on the network; operating the network with the maximum number of devices; determining that at least one of the maximum number of devices has failed; removing the at least one of the maximum number of devices from the network whenever the at least one of the maximum number of devices has failed, the at least one of the maximum number of devices having a first address; connecting the at least one spare device to the network; determining the first address by the at least one spare device; assuming the first address by the at least one spare device; and operating the network with the at least one spare device in place of the at least one of the maximum number of devices.

Another embodiment of the present invention may comprise a network having a maximum number of devices and at least one spare device comprising: a network architecture having the maximum number of addresses corresponding to the maximum number of devices; a plurality of devices attached to the network, the number of the plurality of devices corresponding to the maximum number of addresses; at least one spare device adapted to determine an unallocated address that is not used by another device and using the unallocated address as the network address for the at least one spare device; a plurality of switches attached to each of the plurality of devices and the at least one spare device and adapted to connect and disconnect the each of the plurality of devices and the at least one spare device to and from the network; and a controller adapted to control each of the plurality of switches.

Yet another embodiment of the present invention may comprise a network with automated spares comprising: a device means for individually communicating on the network, the device means being greater than the number of addresses available on the network, at least one of the device means being a spare device means; a switch means connected to each of the device means and adapted to connect or disconnect each of the first means to the network individually; and a controller means for determining if at least one of the device means is to be removed from the network, causing the switch means to disconnect the at least one device means from the network and connecting the spare device means to the network.

The advantages of the present invention are that the number of spare devices for a network of devices is not allocated among the devices that are addressable on the network. Thus, the number of spares does not have a detrimental effect on the number of initially usable devices. Further, spare devices may be automatically swapped with a failed device and the failed device is completely removed from the network.

### BRIEF DESCRIPTION OF THE DRAWINGS

In the drawings,

FIG. 1 is an illustration of an embodiment of the present invention showing a network with switchable spare devices.

FIG. 2 is an illustration of another embodiment of the present invention showing a network with switchable spare devices.

FIG. 3 is an illustration of an embodiment of the present invention showing a method for managing devices on a network.

FIG. 4 is an illustration of an embodiment of the present invention showing an arbitrated loop network of several devices.

### DETAILED DESCRIPTION OF THE INVENTION

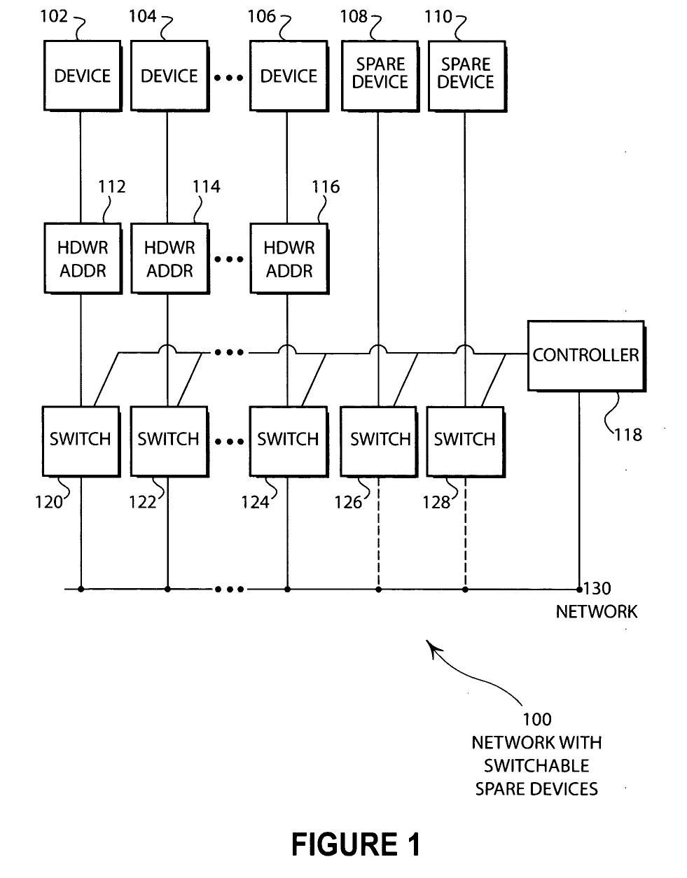

FIG. 1 illustrates an embodiment 100 of the present invention showing a network with switchable spare devices. Devices 102, 104, and 106 and spare device 108 and 110 are connected to the network 130. The devices 102, 104, and 106 are connected to the network 130 through hardware addresses 112, 114, and 116, respectively, and switches 120, 122, and 124, respectively. The spare devices 108 and 110 are connectable to the network 130 through switches 126 and 128, respectively. The controller 118 is connected to switches 120, 122, 124, 126, and 128 and is operable to control each of the switches individually.

The number of addressable devices on the network 130 may be occupied by all of the devices 102 through 106, leaving the spare devices 108 and 110 without an address on the network 130. In such a case, the spare devices 108 and 110 may be switched off of the network 130 when all of the addresses are used by other devices. Because each device 102-110 is connected to the network 130 through switches 120-128, respectively, the controller 118 may be able to connect and disconnect devices with the network 130.

For example, if all of the address spaces are occupied by devices 102-106, then the spare devices 108 and 110 may be switched off of the network. If one of the devices 102, 104, or 106 fails, the controller 118 may switch the failed device off of the network 130 and switch one of the spare devices 108 or 110 onto the network 130. In such a manner, a failed device may be replaced by a spare device.

In many communication networks, a finite number of addresses are available for devices attached to the network. Each network system has a protocol that may define the exact number of communication lines and sequencing of data on the communication lines to allow communication between devices to occur. Examples of such networks include SCSI, Fibre Channel, and other inter-device communication networks. Those skilled in the art will appreciate that various networks and communication protocols may be used with the present invention while keeping within the spirit and intent of the present invention.

In some embodiments, it is desirable to have spare devices. For example, in an embodiment of a disk array, spare disk drive devices may be desired in order to take the place of a disk drive device that fails. In such an example, the various disk drive devices may be connected to a RAID controller or other storage array controller that may allocate data to the disk drive devices according to a protocol. Various protocols, such as RAID 1, RAID 3, RAID 5, and other protocols may have the ability to store data in a redundant fashion, such that if one of the disk drive devices fails, the data is not lost.

In an embodiment of the present invention using a RAID protocol and several disk drive devices, all of the addresses of a communications network may be allocated to useable disk drive devices. In the event of a failure of one of the disk drive devices, the failed device may be switched off of the network and a spare device may be switched onto the network. The spare device that is placed onto the network may be rebuilt according to the protocol for storing the data in a redundant fashion.

By using the present invention, an unlimited number of devices may be allocated as spare devices. For example, when using a network with a maximum of 64 addressable devices, two addressable devices may be allocated for controllers and 62 remaining addressable devices may be allocated as operable disk drives. An unlimited number of spare disk drive devices may be switched off of the network but may be available for replacing one of the 62 disk drive devices. The number of spare disk drive devices may be two, eight, twenty, or more. The number of spare disk drive devices may be determined by the estimated failure rate of the disk drive devices and the desired mean time between servicing.

The embodiment 100 provides individual switches to isolate or remove each device individually from the network 130. In a scenario where one of the useable devices becomes unstable, the unstable device may cause the network to malfunction and the unstable device may then be completely removed from the network. For example, if a device has a communications failure, the device may completely disable communication on the network 130. When the offending device is recognized by the controller 118, the controller 118 may completely isolate the device by activating the appropriate switch 120-128, thereby enabling the network 130 to function properly.

The ability to isolate and remove a failed device from the network 130 is an important feature for very high uptime systems. In such systems, the ability to remove a failed device so that the device does not cause any ancillary failures, such as causing the network to malfunction, is important to allowing the system to correct a problem and continue functioning. After one or more of the devices have failed and are switched off of the network 130, a service technician may be summoned to replace the failed units. When swapped out, the replaced devices may become allocated by the controller 118 as newly available spare devices.

The hardware addresses 112, 114, and 116 may be predetermined addresses that are used by each of the devices 102, 104, and 106, respectively, for the initial addresses on the network 130. The spare devices 108 and 110 may be capable of arbitrating on the network 130 to determine an unused address and assume the unused address for all further communications. The arbitration mechanism for determining a usable address may be defined by the specific network communication protocol being used. In some cases, the address to be used by the spare devices 108 and 110 when the spare devices 108 and 110 are switched onto the network may be provided by the controller 118.

The hardware addresses 112, 114, and 116 may be initial addresses that are determined by a designer. The addresses may be actual electrical hardware devices or wires that are used by the various devices to assume specific network addresses. In other embodiments, the hardware addresses 112, 114, and 116 may be firmware or software settings that are predetermined. In some embodiments, the hardware addresses 112, 114, and 116 may eliminate complex arbitration and address allocation that may occur when many devices are simultaneously arbitrating for addresses. Such design tradeoffs may be determined on the specific network protocol. In some embodiments, the hardware addresses 112, 114, and 116 may not be used.

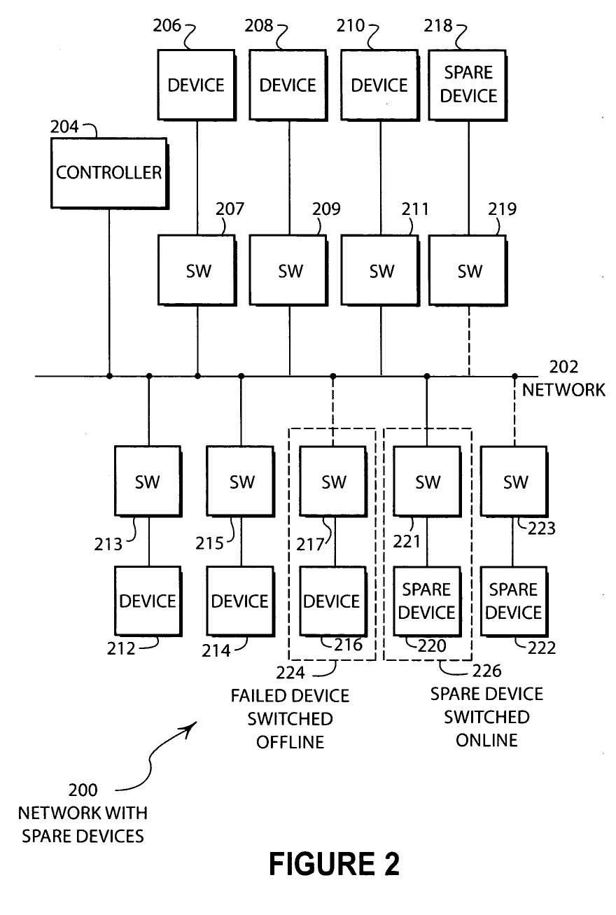

FIG. 2 illustrates an embodiment 200 of the present invention showing a network with spare devices. The network 202 has a controller 204 and several devices 206, 208, 210, 212, 214, and 216 attached to the network 202 by switches 207, 209, 211, 213, 215, and 217, respectively. Three spare devices 218, 220, and 222 are connected to the network 202 by switches 219, 221, and 223, respectively.

In the embodiment 200, the device 216 has failed and may be switched offline as indicated by box 224. When the device 216 is brought off line, spare device 220 may be switched on line as indicated by box 226.

In some embodiments, by removing device 216, the address of device 216 is ‘freed up’ or unallocated. When the device 220 is placed on line, the device 220 may arbitrate on the network to determine if any addresses are available and may begin using an address that is not otherwise taken. In other embodiments, the controller 204 may assign the address that the spare device 220 is to assume when the spare device 220 is brought on line. In some network protocols, the device 220 may be able to arbitrate on the network, determine an unused address, and assert itself as a device using the previously unused address.

In some embodiments, when the failed device 224 is removed from the network 202 and the spare device 226 is added to the network 202, the controller 204 may cause the network 202 to be restarted, reinitialized, or starting addressing arbitration. In some embodiments, the devices may be capable of arbitrating on the network 202 to determine usable addresses. In other embodiments, the controller 204 may be capable of determining an address for the spare device and assigning such an address to the spare device.

Any type of addressable network architecture may be used with the present invention. For example, a hub and spoke architecture, a token-ring architecture, a serial architecture, or any other type of addressable network structure may be used. Those skilled in the arts will appreciate that various network layouts and architectures, protocols, and devices may be used while keeping within the scope and intent of the present invention.

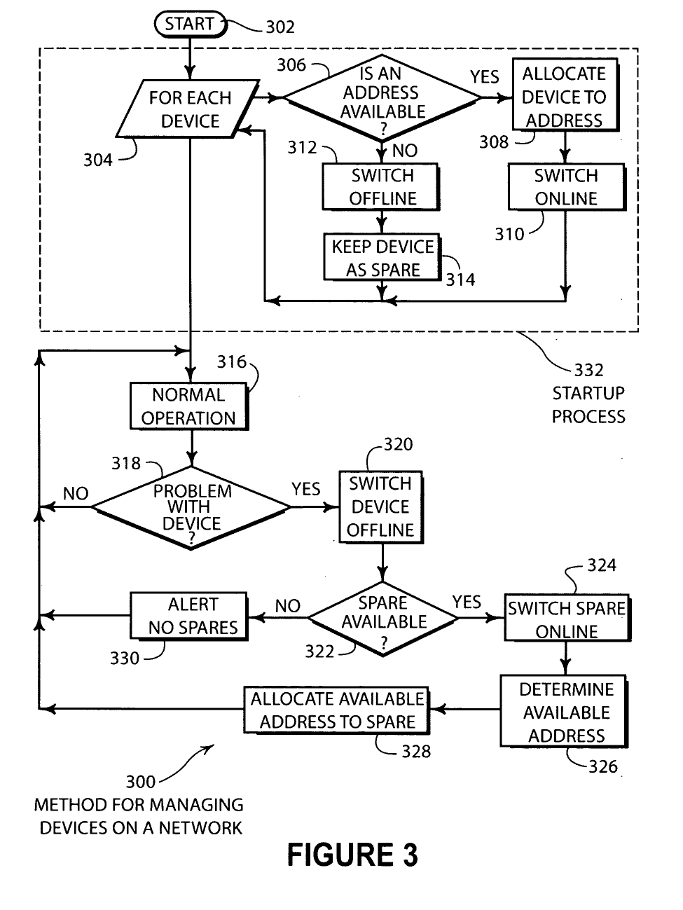

FIG. 3 illustrates an embodiment 300 of the present invention showing a method for managing devices on a network. The process begins in block 302. For each device in block 304, an available address is determined in block 306. If such address exists in block 306, the address may be assigned in block 308 and the device may be switched online in block 310. If an address is not available in block 306, the device may be switched offline in block 312 and the device may be kept as a spare in block 314. Normal operation is performed in block 316. If a problem with a device is detected in block 318, the device is switched offline in block 320. If a spare is available in block 322, the spare is switched online in block 324, the available address is determined in block 326, and the available address is allocated to the spare device in block 328, wherein normal operation is resumed in block 316. If no spare is available in block 322, an alert that no spares are available is sent in block 330 and normal operation is resumed in block 316.

During initial startup process 332, each device is either assigned an address and brought online in block 310 or switched offline in block 312 and kept as a spare. Such a process may be done automatically by an automated controller, performed manually by a technician, be inherent in the layout and configuration of the network connections, or other methods as may be desired.

In the case of an automated controller for the startup process 332, the controller may come online and test each device prior to assigning addresses and bringing the devices online. In some cases, the controller may not assign addresses, per se, but may allow the device to arbitrate for the next available address as the various protocols may require.

In the case of a manual operation for the startup process 332, a technician may set initial addresses for each device using switches, firmware or software settings, or other manual mechanisms for setting addresses or for setting the initial online and offline settings for the various devices. The devices may be capable of determining specific addresses automatically or may require initial settings by the technician.

In the case of an inherent configuration for the startup process 332, a backplane circuit board may be configured with connections for several devices. Each of the specific connections may be assigned an initial address in hardware, firmware, software, or other indicator mechanism. Thus, each of the connections may have specific addresses predefined for devices attached to the connections.

During normal operation in block 316, communication between the various devices and normal functioning of the system occurs. When an error occurs in block 318, the offending device is removed from the network in block 320. By removing the offending device in block 320, the network may be able to properly function.

The errors that may occur in block 318 may include non-responsiveness, repeated communication failures, communication errors, or any other detectable problem with the device. The specific types of errors and threshold for removing the device from the network may be determined by the type of device, the desired system performance, various capabilities of the controller and the network, and other factors. Each embodiment may have differing parameters for determining when a device is taken offline.

If no spares are available, a controller may provide an alert that no spares are available in block 330. Additionally, a controller may provide an alert when any device is taken offline. For example, an amber light may be illuminated when one or more spare devices are put into service and a red light may be illuminated when all of the spares are in service and no more spares are available. A controller may send alerts visually, through a network, via email, or any other mechanism whereby a technician may be alerted to provide service to the system. In some embodiments, a monitoring program may periodically request a status from a network controller. At such time, the network controller may send an alert to the monitoring program in the form of the status request.

The determination of an available address in block 326 may be made by the spare device itself by arbitrating for an unused address on the network. In such a manner, the address may be determined by the spare device without requiring a controller to administer the addresses of the various devices. In other embodiments, the controller may perform the function, depending on the network protocol, system configuration, and other factors.

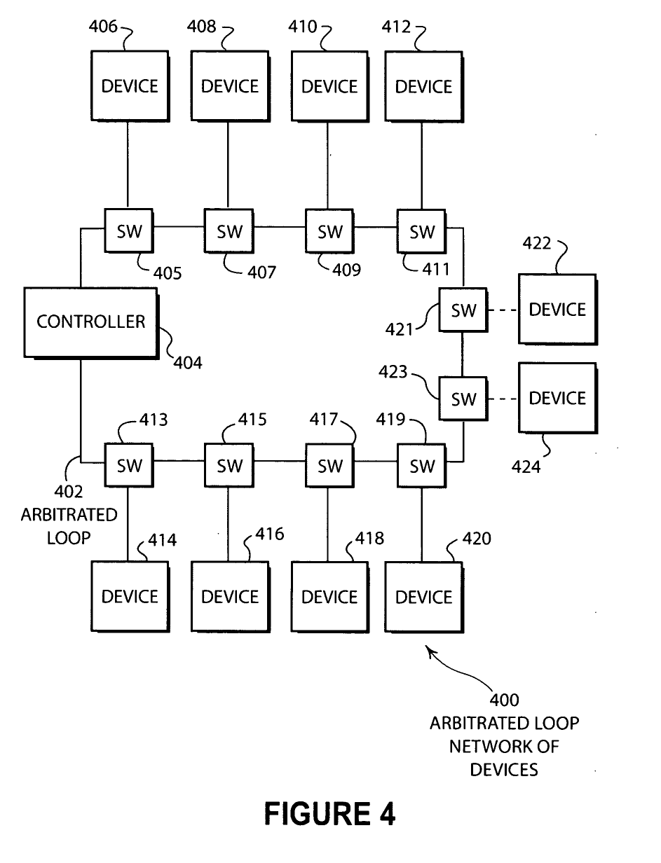

FIG. 4 illustrates an embodiment 400 of the present invention showing an arbitrated loop network of several devices. The arbitrated loop network 402 is controlled by a controller 404, and has devices 406, 408, 410, 412, 414, 416, 418, and 420 connected to the loop 402 by switches 405, 407, 409, 411, 413, 415, 417, and 419, respectively. Devices 422 and 424 are switched off of the loop 402 by switches 421 and 423, respectively.

In the embodiment 400, devices 422 and 424 are switched off of the network, as in a case where the network, or loop, has only eight addressable spaces. If one of the currently used devices were to fail, the respective switch for that device will disconnect the device from the network, and then a switch for a spare device may be activated to connect the spare device to the loop 402. The loop protocol may be reset, allowing the spare device to arbitrate for the address previously used by the failed device. The embodiment 400 illustrates a loop-type architecture implementation of the present invention. An example of such an architecture is Fibre Channel. Many different network architectures may be implemented by those skilled in the art while maintaining within the spirit and intent of the present invention.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for managing more devices on a network than the maximum number of addresses comprising:
providing said maximum number of devices;
connecting said maximum number of devices to said network;
setting an individual address for each of said maximum number of devices;
providing at least one spare device, said at least one spare device being capable of determining and using addresses of failed devices on said network;
operating said network with said maximum number of devices;
determining that at least one of said maximum number of devices has failed;
removing said at least one of said maximum number of devices from said network whenever said at least one of said maximum number of devices has failed, said at least one of said maximum number of devices having a first address;
connecting said at least one spare device to said network;
determining said first address by said at least one spare device;
assuming said first address by said at least one spare device; and
operating said network with said at least one spare device in place of said at least one of said maximum number of devices.

2. The method of claim 1 wherein said step of setting an individual address for each of said maximum number of devices comprises assigning a predetermined address for at least one of said maximum number of devices.

3. The method of claim 1 further comprising:
connecting each of said first number of devices and said at least one spare device to a switch, said switch being adapted to switch said each of said first number of devices into and out of said network; and
connecting each of said switches to a controller adapted to control said switches.

4. The method of claim 3 wherein said step of determining that at least one of said maximum number of devices needs to be removed from said network is performed by said controller.

5. The method of claim 4 wherein said devices comprises a plurality of data storage devices.

6. The method of claim 5 wherein said devices are arranged as at least a portion of a RAID system.

7. A network having a maximum number of devices and at least one spare device comprising:
a network architecture having said maximum number of addresses corresponding to said maximum number of devices;
a plurality of devices attached to said network, the number of said plurality of devices corresponding to said maximum number of addresses;
at least one spare device adapted to determine an unallocated address that is not used by another device and using said unallocated address as the network address for said at least one spare device;
a plurality of switches attached to each of said plurality of devices and said at least one spare device and adapted to connect and disconnect said each of said plurality of devices and said at least one spare device to and from said network; and
a controller adapted to control each of said plurality of switches.

8. The network of claim 7 wherein said controller is further adapted to:
assess the status of each of said plurality of devices;
determine that one of said plurality of devices is improperly functioning;
cause a first of said plurality of switches to disconnect said one of said plurality of devices from said network; and
cause a second of said plurality of switches to connection said at least one spare device to said network.

9. The network of claim 8 wherein said controller is further adapted to reset said network.

10. The network of claim 8 wherein at least two of said plurality of devices is a storage device.

11. The network of claim 10 wherein said storage devices are arranged as a RAID system.

12. A network with automated spares comprising:
a device means for individually communicating on said network, said device means being greater than the number of addresses available on said network, at least one of said device means being a spare device means;
a switch means connected to each of said device means and adapted to connect or disconnect each of said first means to said network individually; and
a controller means for determining if at least one of said device means is to be removed from said network, causing said switch means to disconnect said at least one device means from said network and connecting said spare device means to said network.

13. The network of claim 12 wherein at least two of said plurality of first means is a storage device.

14. The network of claim 13 wherein a plurality of said first means are arranged as a RAID system.
